(19) United States
(12) Patent Application Publication
(10) Pub. No.: US 2019/0385237 A1
(43) Pub. Date: Dec. 19, 2019

(54) TECHNOLOGIES FOR AUTOMATING ADAPTIVE FINANCIAL PLANS

(71) Applicant: PLANSWELL HOLDINGS INC., Toronto (CA)

(72) Inventors: Scott WETTON, Toronto (CA); Eric ARNOLD, Toronto (CA)

(21) Appl. No.: 16/465,037

(22) PCT Filed: Nov. 30, 2017
(86) PCT No.: PCT/CA2017/051442

§ 371 Date: May 29, 2019

Related U.S. Application Data
(60) Provisional application No. 62/428,267, filed on Nov. 30, 2016.

(51) Int. Cl. G06Q 40/06; G06Q 10/06

(52) U.S. Cl. CPC G06Q 40/06; G06Q 10/067

(57) ABSTRACT

A server connected to a user input device issues a first stream of questions to the user input device to obtain responses with inputs for a financial plan model. Some of the inputs define fixed financial objectives. The server executes a financial plan model using the inputs. If the outputs of the financial plan model do not represent a financial plan that is feasible for meeting the fixed objectives, the server issues a second stream of questions to obtain from the user an indication of which fixed objectives can become variable objectives. On receipt of responses defining one or more variable objectives corresponding to some or all of the fixed objectives, the server executes the financial plan model using the variable objectives and issues a most optimal subset of financial plan outputs from amongst any feasible sets of financial plan outputs for presentation on the user input device.

### FIELD

The present disclosure relates to interactive user interface systems and, in particular, to management of user input data and adaptive generation of output data for display to users.

### BACKGROUND

Automation tools have proliferated in the financial services sector. For example, automation tools are available that assist financial planners with calculation aspects of financial plans for their clients. However, it is challenging to deliver accessible financial information to consumers using electronic devices. Some approaches deliver information without considering consumers' financial situations. Other approaches that deliver more tailored information require significant manual and skilled intervention from trained financial advisors or related staff. Further, rather than identifying a subset of optimal outcomes from amongst a plurality of feasible outcomes, many tools require users to manually and iteratively modify different inputs until any feasible outcome is obtained given the remaining entered inputs.

So-called robo-advisors have been developed, but many are restricted to one particular financial domain, such as automated or algorithmic portfolio management advice or services. The problems of this narrow approach are exacerbated by the enormous variety of available financial instruments, such as registered and unregistered accounts, tax-preferred savings instruments, investment and debt instrument, insurance policies, and personal and business assets.

Despite existing approaches, barriers remain to consumer engagement with financial information on their electronic devices.

### BRIEF DESCRIPTION OF THE DRAWINGS

In drawings which illustrate by way of example only embodiments of the present application,

FIG. 1 is an illustration of a data processing environment including user computing devices and server systems.

FIG. 2 is a schematic of select components of a user computing device for use with the data processing environment of FIG. 1.

FIG. 3 is a schematic of select components of a server computing system for use with the data processing environment of FIG. 1.

FIG. 4 is a further schematic of select modules of the server of FIG. 3.

FIG. 5 is a schematic illustrating an example financial plan model as executed in the server of FIG. 3.

FIG. 6 is a schematic illustrating an example financial plan output as presented on the user computing device according to an arrangement defined by a financial plan template.

FIG. 7 is a flowchart illustrating methods executed in the server of FIG. 3 for generating a financial plan output for presentation on the user computing device.

FIGS. 8 and 9 are schematics illustrating example questions presented on the user computing device.

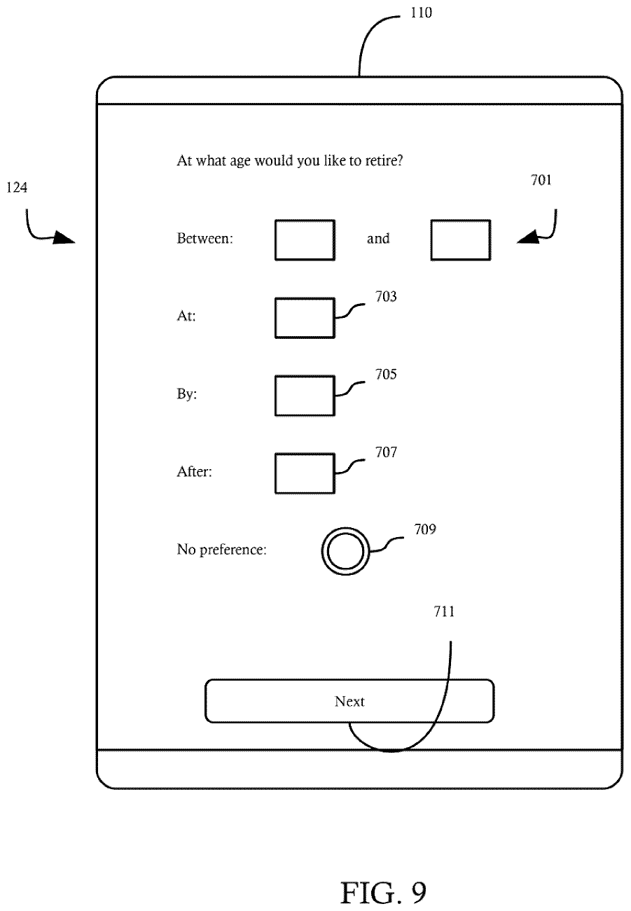

FIG. 10 is a schematic illustrating an example notification presented on the user computing device.

FIGS. 11 and 12 are charts illustrating an example user's financial plan models using first and second streams of responses, respectively.

### DETAILED DESCRIPTION

The examples and embodiments described in this disclosure provide systems, methods, and data processing device-readable media for implementing and managing adaptive financial plans presented to user interfaces.

These examples and embodiments enable direct user- or, more specifically, consumer-, engagement with the development of feasible and user-specific financial plans without requiring the involvement—manual or otherwise—of other operators, such as financial planners, specialized data entry personnel or financial advisors. A financial plan model is provided which, when executed by a processor of a computer system, provides a platform that enables the generation and presentation of outputs corresponding to one or more financial plan scenarios based on consumer-provided responses to adaptive user interfaces generated by the computer system for presentation on the consumer's computing device. Initially, the user interfaces present a stream of questions to obtain from the consumer an idealized set of objectives for that consumer's financial plan. Unlike existing approaches, however, these examples and embodiments provide an approach for directly engaging the consumer in generating a feasible financial plan when none is available to meet the consumer's idealized set of objectives. Conventionally, a skilled advisor or planner would, based on experience, skill and judgment, respond to such a failure by manually and iteratively adjusting inputs until any feasible financial plan results. Since the input process in conventional systems can be complex, the consumer tends to play a passive role in this process. Instead, the advisor generally must either ask the consumer where he or she is willing to sacrifice objectives, or the advisor makes that decision without further consultation.

The examples and embodiments in this application provide an approach in which the computer system generates a subsequent series of user interfaces presented to the consumer with a follow-up stream of questions. These user interfaces engage the consumer to identify his or her priorities amongst the previously indicated, idealized objectives for the financial plan. Rather than requiring the consumer to manually and iteratively attempt different values for those objectives until a feasible financial plan can be reached, the consumer is only required to indicate priorities that define where and how the computer system should automatically adjust those objectives in executing the financial plan model. Thus, the computer system is operable to generate a feasible financial plan by treating one or more of the idealized objectives as a preference rather than as a fixed constraint on the financial planning model. The computer system respects the consumer's priorities while seeking an optimal financial plan that comes close to the consumer's indicated ideal —without requiring the consumer or another operator to manually and iteratively submit different fixed objectives in an attempt to identify any feasible outcome.

These examples and embodiments include a computing environment which enables the execution of an integrated financial plan model in response to adaptive questions between a computer system and consumers through user computing devices. The financial planning model, when executed by a processor of the computer system, generates one or more sets of financial plan outputs, each set corresponding to a financial plan scenario based on a consumer's indicated inputs in response to a questionnaire. The computer system, then, is operable to generate periodic cash flow, income, expense, debt, investment and other analyses to verify the feasibility of one or more possible scenarios against inputs from the consumer reflecting his or her objectives and existing financial situation. Further, the computer system is operable to assess, from amongst a plurality of feasible scenarios, which is more optimal in view of the consumer's objectives.

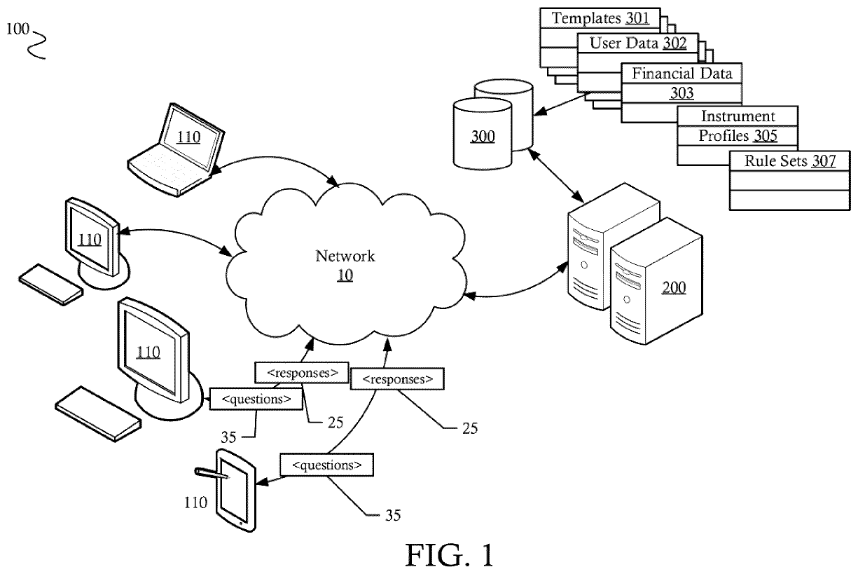

These embodiments and examples are described and illustrated primarily in the context of a data processing environment comprising one or more data processing systems, which may operate over a local or wide-area network. FIGS. 1-4 illustrate select components of a networked data processing system and computing devices or systems that are suitable for use with the contemplated embodiments.

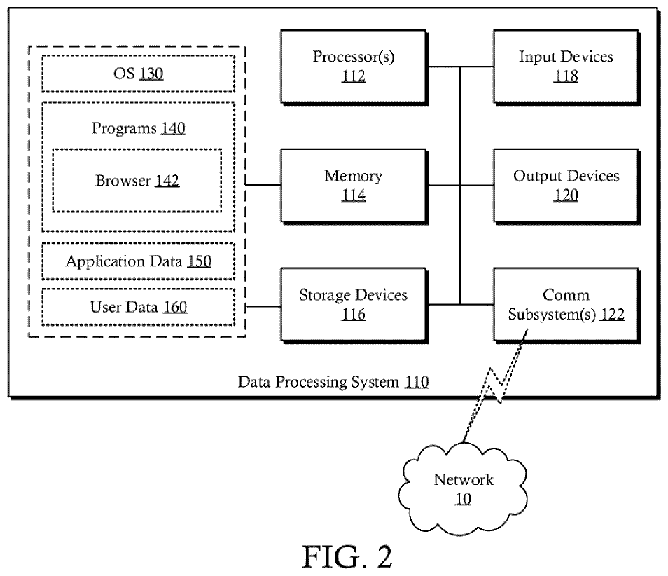

The present automated and adaptive financial planning system can be implemented using user computing devices 110 and server data processing system 200 in communication over a network 10 in a data processing environment 100 like that illustrated in FIG. 1. FIG. 1 illustrates one possible network topology, and is not limiting. In this example, several user computing devices 110 communicate with a server data processing system 200 over a wide area network 10, such as the Internet. The network 10 need not be the Internet, or a wide area network; the network 10 may be public or private, wide or local, fixed or wireless. However, a likely implementation will be over the Internet or a wide area network, in view of the current popularity of cloud-based services. In a typical implementation, the user computing devices 110 and the server system 200 may be physically and geographically removed from one another. In other implementations, however, the two systems may be provided at the same physical location, for instance, in communication over a local area network. Either way, the user computing devices 110 and server system 200 may be considered either physically or logically “remote” from one another. The user computing devices 110 and server system 200 are described in further detail with reference to FIGS. 2-4. Briefly, users (not shown) operating user computing devices 110 communicate with the server system 200 over the network 10 to provide user-generated inputs 25 in response to questions 35 from the server system 200. The server system 200 processes and stores received user communications in a data store or stores 300. The data stores 300 operated by the server system thus store the user-generated inputs 25, user account data 302, financial data 303, rule sets 307 and templates 301, as well as financial instrument profiles 305 defining available financial instruments.

FIG. 2 is a block diagram of select components of an example user computing device 110, which may be embodied in a single device, such as, but not limited to, a desktop computer, workstation or terminal, or mobile computer (e.g., laptop computer, tablet computer, or smartphone). While the example user computing device 110 is illustrated herein as a smartphone, desktop computer or laptop, it will be appreciated by those skilled in the art that this is not intended to be limiting, and the solutions described in this disclosure may be implemented on any suitable data processing device that is configurable to operate as described, whether or not this device is primarily intended for productivity uses or other types of uses.

Operation of the user computing device 110 is generally controlled by a main processor or processors 112. The user computing device 110 may be operated under mains power or may be a battery-powered device, not shown. Data, programs, and other instructions or information can be stored in one of several possible memory components of the user computing device 110, such as internal memory 114 (which can include standard volatile and non-volatile memory components, which can be integrated with other components such as the processor 112 or provided as distinct components). Information can also be stored in the user computing device 110 on other storage devices, either internal or external, such as hard drives, flash drives, memory cards, and peripheral devices, not shown in FIG. 2. Typically, software and data components such as the operating system (OS) 130, programs (applications) 140, locally stored application data 150, and user data 160 are stored in resident persistent memory. In some systems 110, some components of the OS 130 may be embedded as firmware in integrated memory in the processor 112. However, portions of such components may be temporarily loaded into volatile memory. In this example, the programs 140 can include, among others, a general-purpose user agent such as a web browser application 142 which is used to access the financial planning system. Alternatively, a dedicated application (not shown) may be provided to implement the examples described here. Implementation using a browser 142 provides, among other advantages, improved mobility and portability on the part of users, who may be distributed globally or across a wide geographic area. Application data 150, which can include configuration information, and user data 160, which can include contacts, message stores, word processing files, and the like, may be stored in resident persistent memory of the user computing device 110, or in a storage device 116.

The user computing device 110 is provided with user or sensor input devices 118. User input devices can include a touch and/or pointing device, such as a touchscreen, touchpad, mouse, or trackball; a keyboard; security peripherals such as a biometric scanner; and multimedia input devices, such as cameras or microphones. The user computing device 110 may also have environmental or contextual input devices such as an orientation or inertial navigation sensor (particularly in the case of a touchscreen device), ambient light sensor, or a global positioning system (GPS) or other location detection module. The user computing device 110 can also include one or more output devices 120, including, in particular, a display screen, which may be integrated in the chassis of the user computing device 110, or else provided as a peripheral device. The user computing device 110 may be configured to output data to an external monitor or panel, tablet, television screen, projector, or virtual retinal display, via a data port or transmitter, such as a Bluetooth® or WiFi® transceiver, USB port, HDMI port, DVI port, and the like. The data port or transmitter may be one of the communication subsystems 122 illustrated in FIG. 2. Graphics data to be delivered to the display screen is either processed by the processor 112, or else by a dedicated graphics processing unit, not included in FIG. 2. Other output devices include speakers, and haptics modules. Not all of these suggested input or output devices are required, and many may be omitted. For instance, where the primary user interface of the user computing device 110 is a touchscreen, a physical keyboard may be omitted altogether.

Communication functions, comprising at least data and optionally voice communications, are performed through one or more communication subsystems 122 in communication with the processor 112. Other functional components used to accomplish communication functions, such as antennae, decoders, oscillators, digital signal processors, and the like, may be considered to be part of these subsystems. Wireless communication subsystems are used to exchange data with wireless networks or other wireless devices in accordance with one or more communications standards, including, without limitation, wireless LAN (e.g., one or more of the 802.11™ family of standards), Bluetooth® and the like. The particular design of a communication subsystem is dependent on the communication network 10 with which it is intended to operate. The communication subsystems 122 may include adaptors for use with wired connections as well.

It will be understood by those skilled in the art that the components illustrated in FIG. 2 are merely representative of particular aspects of the user computing device 110, and that other components that are typically included in such a device have been excluded in the drawings and this description only for succinctness. Furthermore, those skilled in the art will understand that the user computing device 110 may be successfully used with the various examples described herein even when some components described in relation to FIG. 2 are omitted.

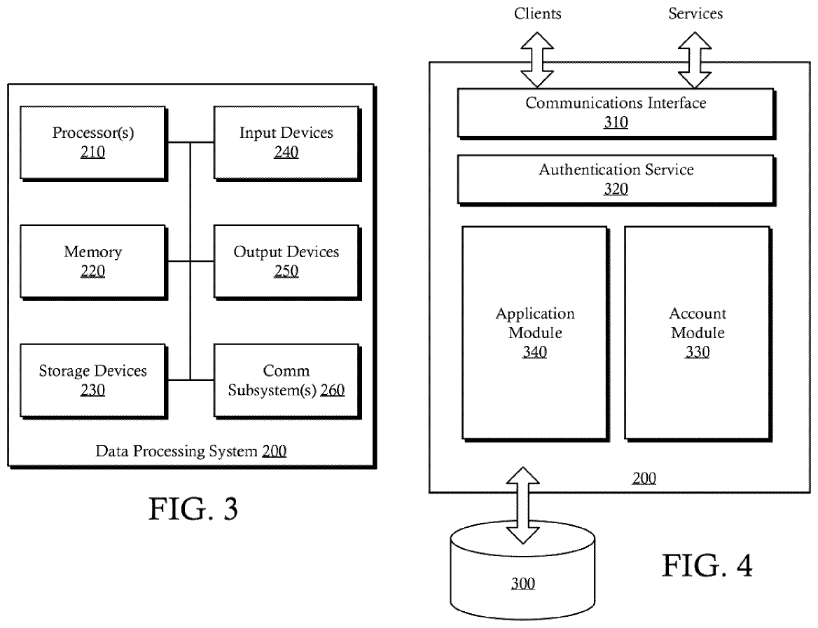

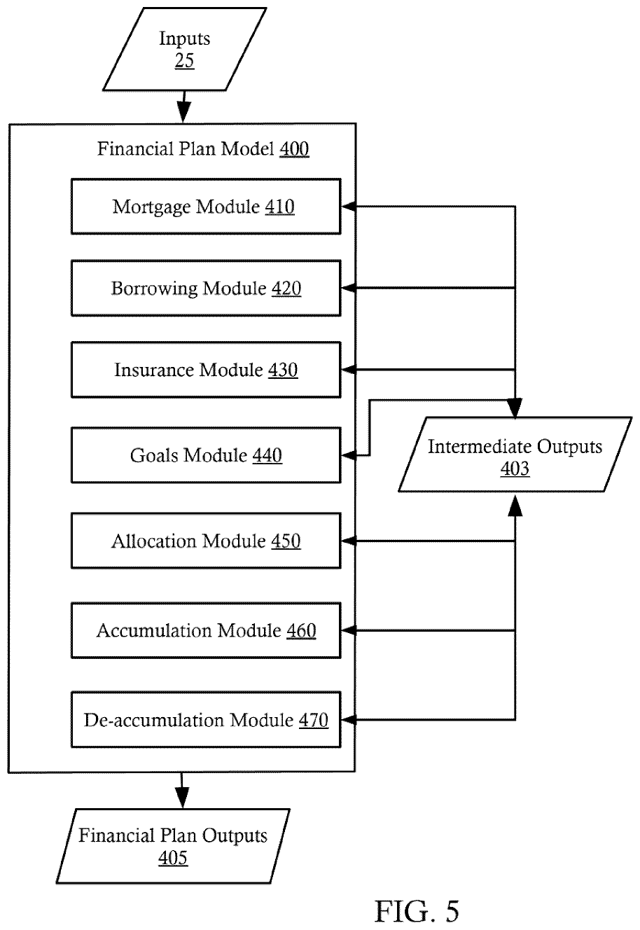

Select components of a server data processing system 200 are illustrated in FIGS. 3 and 4. Again, it will be appreciated by those skilled in the art that these components are merely representative, and that some of these components may be omitted or substituted while still achieving successful operation of the embodiments and examples described herein. In FIG. 3, components similar to those of the user computing device 110 are illustrated, including one or more processors 210, memory 220, storage devices 230, input and output devices 240, 250 respectively, and communication subsystems 260. The appropriate selection of components for a server system 200 will be known to those skilled in the art. While the server system 200 may include local storage devices 230, data processed or managed by the server may be stored remotely from the server system 200, for example in the data storage system 300 illustrated in FIGS. 1 and 4.

FIG. 4 illustrates components of the server system 200 from a functional perspective. These components interact with each other to provide the financial planning system. The system 200 may include a communications interface module 310, which brokers communication with external systems or services, including user computing devices 110, and optionally third-party or remote systems supporting other functions, such as a payment transaction system (not illustrated). The communications interface module may include an HTTP server, where user computing devices 110 access the server system 200 using a web browser. The system 200 can also include an authentication service 320 for authenticating users and granting access to the functions provided by the server system 200, and an associated account module 330 which manages user account information (e.g., contact information, user identity, tracking user compliance with terms of service, etc.). In some implementations, the authentication service 320 may be operated by a third party on behalf of the operator of the server system 200, and thus not included in the system 200. The account module 330 can also operate to manage user permissions with respect to the financial plans managed by the system 200.

The example server system 200 of FIG. 4 also includes an application module 340, which executes code to financial plan data and outputs, notifications and streams of questions (e.g., webpages or other media) for delivery to user computing devices 110, and receive inputs from users at their devices 110, via the communications interface 310; processes received inputs; manages financial plans, inputs from users and financial data from other systems, stored in the data storage system 300, as described below. Administrative modules employed by the operator of the server system 200 for maintenance and updating of various system functions are not illustrated.

The various functional units of the server system 200 may be implemented across multiple data processing devices and multiple data storage systems, and not merely one data processing system or data storage system as schematically illustrated herein. Thus, for example, the system 200 may comprise a discrete application server rather than an application module 340.

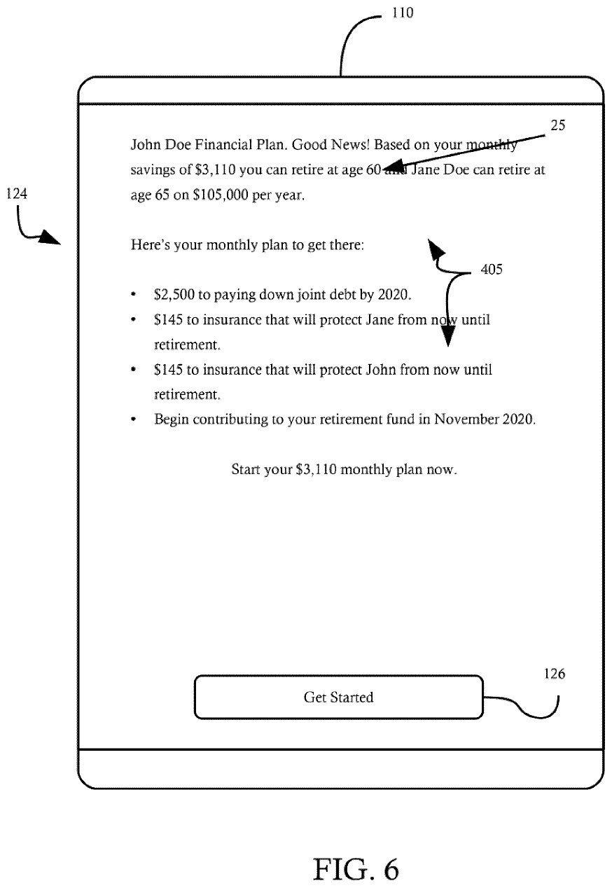

FIG. 5 illustrates, in schematic form, one example arrangement of components of an integrated financial plan model 400 that is organized according to a modular relationship in which various modules model, more or less independently, distinct aspects of the integrated financial plan model 400. In the illustrated example, which is by no means limiting, the financial plan model 400 comprises a mortgage module 410, a borrowing module 420, an insurance module 430, a goals module 440, an asset allocation module 450, an accumulation module 460, and an asset de-accumulation module 470. Each module is defined by logic or rules dedicated to a specific financial aspect of the overall financial plan model 400. In this example, the mortgage module 410 models mortgage-related aspects of the financial plan model 400, while the insurance module 420 models insurance-related aspects. The aspect-specific rules that define each module are directed to processing of relevant inputs 25 obtained over the network 10 from the user's device 110, the data storage system 300 and any other remote systems, platforms or databases, to provide intermediate outputs 403 for further processing by other modules or final, financial plan outputs 405 directly for presentation on the user's device 110 according to a suitable financial plan template 301 stored in the data storage system 300. As shown in FIG. 5 and in Table 1 below illustrate example modules of the financial plan model 400, their inputs 25, whether user-defined or system-defined, their rules and their outputs 403, 405. The tabular layouts in this disclosure do not necessarily represent the data in which the model, template or financial plan is stored or represented by the system 200.

TABLE 1
Modules of a Financial Plan Model
Financial Plan Model

| Module | Input | Defined? | Rule | Output |
|---|---|---|---|---|
| <mortgage> | <house purchase | <user> | <mortgage | <term> |
| | price> | | rules> | <payment> |
| | <down payment> | | <validation | <amortization> |
| | <desired term> | | rules> | <rate> |
| | <desired | <system> | | |
| | amortization> | | | |
| | <desired | | | |
| | payment> | | | |
| | <available | | | |
| | mortgage rates> | | | |
| | <predicted | | | |
| | mortgage rates> | | | |
| | <available term> | | | |
| | <available | | | |
| | amortization> | | | |
| | <refinancing | | | |
| | amounts> | | | |
| <borrowing> | <high-interest | <user> | <borrowing | <suggested low |
| | loans> | | rules> | interest loan |
| | | | | instrument> |
| | <available low | <system> | | |
| | interest loan | | | |
| | instruments> | | | |
| <insurance> | <income> | <user> | <insurance | <insured |
| | <age> | | rules> | amounts> |
| | <employer | | | <insured risks> |
| | insurance> | | | <insurance |
| | <spousal | | | premiums> |
| | insurance> | | | |
| | <spousal | | | |
| | requirements> | | | |
| | <house | | | |
| | purchase | | | |
| | price> | | | |
| | <dependent | | | |
| | requirement> | | | |
| | <available | <system> | | |
| | insurance | | | |
| | instruments> | | | |
| <goals> | <milestone | <user> | <goals rules> | <recommended |
| | dates> | | | investment |
| | <milestone | | | instruments> |
| | amounts> | | | <recommended |
| | <general risk | | | allocation |
| | tolerance> | | | amounts> |
| | <available | | | <recommended |
| | investments> | | | allocation |
| | | | | dates> |
| | <available | <system> | | |
| | investment | | | |
| | instruments> | | | |
| <allocation> | <available | <user> | <asset rules> | <account |
| | savings> | | <tax rules> | allocation> |
| | <existing | | | |
| | assets> | | | |
| | <available | <system> | | |
| | account types> | | | |
| <accumulation> | <risk | <user> | <accumulation | <calculated |
| | tolerance> | | rules> | returns> |
| | <payment> | | | |
| | <current cash | | | |
| | flow> | | | |
| | <desired | | | |
| | savings> | | | |
| | <retirement | | | |
| | employment | | | |
| | income> | | | |
| | <planned | | | |
| | windfalls> | | | |
| | <predicted | | | |
| | future | | | |
| | income> | | | |
| | <future cash | <system> | | |
| | flows> | | | |
| | <predicted | | | |
| | inflation> | | | |
| | <de-risked | | | |
| | rates of | | | |
| | return> | | | |
| <de- | <desired | | <de- | <draw-down |
| accumulation> | retirement | | accumulation | plan> |
| | income> | | rules> | |
| | <desired | | <tax rules> | |
| | retirement | | <entitlement | |
| | age> | | rules> | |
| | <home | | <actuarial | |
| | equity> | | rules> | |
| | <entitlements> | | | |
| | <entitlements> | | | |
| | <life | | | |
| | expectancy> | | | |

As illustrated in Table 1 above, the mortgage module is defined by mortgage rules with user-defined inputs 25, such as <purchase price>, and system-defined inputs, such as <available mortgage rates>. The system-defined inputs are stored in the data storage system 300 and may be predefined values which a system administrator has entered, or the system 200 may periodically retrieve and update those inputs from external systems, platforms or databases. For example, the system 200 may obtain current data from third party financial service providers through their respective platforms or web pages to define the <available mortgage rates>, <available term> and <available amortization> inputs of the <mortgage> module. In contrast <user> defined inputs are those which the user provides in response to a stream of questions from the system 200. The non-limiting example shown in Table 1 refers to various inputs as <user> defined or <system> defined. However, it will be appreciated that a given input need not be <user> defined if the <system> has access to that input from a different source or is able to calculate the input value from other inputs available to it. Similarly, the system 200 may compare user-defined and system-defined input to identify errors and prompt the user to confirm which is accurate.

The rules that define each module can also include validation rules to validate that user inputs satisfy internal constraints of that module. For example, the mortgage module 410 may comprise <validation rules> which, when executed by the application module 340, would detect that a user's inputs indicating a <desired mortgage payment> would be unfeasible given the indicated <desired term> or other indicated parameters, even if the application module has not yet executed all components of the financial plan model 400. In response to detecting a breach of the <validation rules>, then, the server system 200 would issue a notification over the network 10 to the user computing device 110 to provide the user with an opportunity to reconcile the erroneous entries that caused the error. In the illustrated example at Table 1, only the <mortgage> module 410 is shown comprising <validation rules>; however, <validation rules> can be included in any module or more generally in the financial plan model 400. For example, the financial plan module 400 could further comprise a validation module (not shown).

Various prediction models are available which, if included in the financial plan model 400, can lead to a relatively accurate representation of the user's future parameters. For example, the user's future income may not be accurately represented relying solely on the user's current income, even with adjustments for inflation. Thus, the stream of questions may comprise questions directed at determining future earnings expectations for the user, for example, by asking the user to provide estimated salaries for similarly positioned workers 5, 10, 15 years ahead of the user. In the accumulation module 460, for example, a <predicted future income> input includes potential income growth in the financial plan model 400.

While the financial plan model 400 is not necessarily modular, a modular arrangement like that shown in FIG. 5 is conducive to targeted updating and implementation of the financial planning model 400, depending on the case which the system 200 is modelling. For example, if a user indicates that he or she does not own, or intend to own, a house, then there is no need to model mortgage aspects of that user's financial plan. Further, if a substitute mortgage calculation model is developed (for example, based on a machine-learning or other analysis of outcomes of a plurality of other users' stored financial plan data), a system administrator can update the mortgage module 410 without regard to the impact on other elements of the financial plan model 400, provided the updated mortgage module 410 remains compatible with the inputs 25 and outputs 403, 405 common to the entire financial plan model 400. Inputs 25 into, and outputs 403 generated from, the financial plan model 400 may be shared between multiple modules within the financial plan model 400. For example, as shown in Table 1, the user-input <house purchase price> indicating the purchase price of the user's house may relate to the mortgage module 410 and the insurance module 430 since the purchase price may dictate the user's mortgage and insurance requirements. Further, an intermediate output 403 of one module may serve as an input to one or more of the other modules in the financial plan model 400, as illustrated by the flow lines between the intermediate outputs 403 and the modules in FIG. 5. A monthly mortgage <payment> calculated as an output 403 of the mortgage module 410 may serve as an input to the accumulation module 460 in certain financial planning models. Accordingly, a different or alternative mortgage module 410, if substituted for the existing mortgage module, would maintain compatibility with the accumulation module 460 if the alternative or replacement module continues to generate as an output 403 at least a mortgage <payment>.

As shown in FIG. 5 and in Table 1, the financial plan model 400 may comprise a goals module 440. The goals module 400 receives the user's major spending <milestone amounts> and <milestone dates> as inputs 25 from the user in response to a stream of questions. In recognition of those milestones, the goals module 440 constrains the financial plan model 400 so that the user's investments are reallocated periodically to ensure that sufficient funds are available to meet those milestones. Even if a user indicates a high degree of <general risk tolerance>, when executing the goals module 440 of the financial plan model 400, the application module 340 calculates periodic allocations of assets from higher risk investment instruments into lower risk investment instruments in anticipation of each milestone based on the assumption that a user either will not tolerate any risk of missing the indicated milestone or that the user's risk tolerance for the milestone amount is different from the user's general tolerance. The goals module 440, then, may comprise <goals rules> to ensure that the risk profile of the user's investments maximizes the potential for return while also avoiding risk that there would be insufficient funds available to meet the indicated <milestone amounts> and <milestone dates>. The <goals rules> assess, on a periodic basis, the allocation of investments between two or more <available investment instruments> each with different risk profiles that ensures sufficient funds on the <milestone dates> while maximizing the weighted rate of return of the user's<available investments> within the user's risk tolerance. The user's risk tolerance may be based on the user's response to “know-your-client” questions within a stream of questions issued to the user computing device 110. A non-limiting example of a scenario considered by the goals module 440 is shown below in Table 2.

TABLE 2
Example milestone calculation performed by goals module.

| | | | Investment Instruments | | | | | |
|---|---|---|---|---|---|---|---|---|
| | | | Ultra | | | | Ultra | |
| Plan | | | Low | Low | Mid | High | High | Weighted |
| Year | Milestone | Contributions | 1% | 2.75% | 4% | 5.5% | 6.5% | Return |
| 1 | — | $6,000 | — | — | $68,000 | — | $242,000 | 5.95% |
| 2 | — | $6,000 | — | $74,000 | — | — | $260,450 | 5.67% |
| 3 | $80,000 | $6,000 | $80,000 | — | — | $32,000 | $247,414 | 5.19% |
| 4 | — | $6,000 | — | — | $38,000 | — | $266,056 | 6.19% |
| 5 | — | $6,000 | — | $44,000 | — | — | $284,870 | 6% |
| 6 | $50,000 | $6,000 | $50,000 | — | — | — | $304,596 | 5.72% |
| . | . | . | . | . | . | . | . | . |
| . | . | . | . | . | . | . | . | . |
| . | . | . | . | . | . | . | . | . |
| 18 | — | $6,000 | — | — | — | $47,000 | $706,639 | 6.44% |
| 19 | — | $6,000 | — | — | $53,000 | $53,000 | $702,262 | 6.27% |
| 20 | — | $6,000 | — | $59,000 | $59,000 | $59,000 | $687,944 | 6.01% |
| 21 | $65,000 | — | $65,000 | $65,000 | $65,000 | $65,000 | $662,888 | 5.6% |
| . | . | . | . | . | . | . | . | . |
| . | . | . | . | . | . | . | . | . |
| . | . | . | . | . | . | . | . | . |

According to the example scenario illustrated above in Table 2, a user's 46-year financial plan includes planned milestones of $80,000 at year 3, $50,000 at year 6, and $65,000 in each of years 21-46 (these latter milestones corresponding to the user's retirement). The user's investments can be allocated amongst ultra low-, low-, medium-, higher- and ultra high-risk investment instruments each with expected annual performance at 1%, 2.75%, 4%, 5.5% and 6.5% respectively. For example, those investment instruments may correspond to a risk profile dictated by the user's responses to “know-your-client” type questions in a stream of questions. For example, the user may provide responses indicating that the user's general risk tolerance is “ultra high” generally, but that the user's risk tolerance is “ultra low” in year 3 for missing the $80,000 milestone in the same year. Similarly, the user may indicate a “mid” tolerance in year 4 for missing the $50,000 milestone in year 6, while also indicating “low” and “ultra low” risk tolerances in years 5 and 6, respectively, for missing that milestone. Based on system-predicted available contributions for each year, the illustrated goals module 440 also accounts for available contributions in meeting milestones. As shown in the example of Table 2, the user makes annual contributions of $6,000 to the original available investment of $310,000. The system reallocates money between five investment instruments once per year; however, reallocation may occur at other intervals, such as daily, weekly, monthly, annually or less frequently, based on defined tolerances for each financial plan record, and amongst any number of investment instruments, such as five or ten or more. Given that the user demands to have $80,000 accessible at the end of year 3 (with a declining risk tolerance profile of “mid”, “low” and “ultra low” in each of years 1, 2 and 3, respectively), the milestone module 440 allocates $68,000 toward that milestone in a “mid”-risk investment instrument. The residue remains in an “ultra high”-risk investment instrument because that instrument matches the user's generally “ultra high” risk tolerance profile for long-term investments that is likeliest to maximize long-term returns on investments that the user will not need for some time. The resulting weighted rate of return of the user's investments in year 1, then, is 5.95%. By the beginning of year 2, the user has contributed $6,000. That contribution, in addition to the weighted return on the user's savings in year 1 leads to total investments of $334,450 (not shown) at the beginning of year 2 divided into two amounts: $74,000 in the “low”-risk investment instrument and $260,450 in the “ultra high”-risk investment instrument. At the beginning of year 3, the goals module 440 reallocates the user's investments amongst three different investment instruments, with $80,000 in the “ultra low”-risk investment instrument to ensure availability of the entire amount for the user's milestone. Analogous reallocation occurs periodically (for example, annually, as shown, or more frequently) when necessary to ensure access to milestone amounts.

In years 7-17 (not shown) all investments are allocated into the highest “ultra high”-risk investment instrument since there is still time to recover losses in advance of planned drawdowns beginning in year 21 when the user retires. Although Table 3 illustrates annual reallocations, the <goals rules> may recommend reallocations more frequently, such as hourly, daily, weekly or monthly. Assuming no transaction costs or ancillary factors, more frequent reallocations generally should provide a more refined optimization of outcomes. In addition to transaction costs, risk tolerance, annualized rate of return and other parameters, the financial plan model 400 may further consider the tax implications of the reallocations so that the model is tax- and return-optimized while meeting milestone objective. Thus, as shown in Table 1, the allocation module 460 and the de-accumulation module 470 comprise <tax rules> to optimize tax planning aspects of the financial plan model 400.

The financial plan model 400 further comprises an insurance module 430 that integrates insurance aspects into the financial plan model 400. The insurance module 430 comprises <insurance rules> configured to cause the application module 340 to calculate a user's life, critical illness, and disability insurance requirements. The insurance needs for a user may be based, for example, on the user's need to replace all or part of the user's current and expected future income if the user is incapacitated, on the needs of a beneficiary indicated by the user in response to a stream of questions from the system 200, or on the user's indicated risk tolerance for variances in financial plan outcomes where the tolerance is derived from the user's responses to “know-your-client” questions in a stream of questions, or on the user's level of indebtedness and other suitable factors. The system 200 may reassess the user's insurance and other needs periodically following presentation of an initial financial plan output. For example, the system 200 may reassess the user's term life requirements periodically, such as semi-annually, based on the net present value of the user's anticipated future cash flows. As those estimates change, the insurance module 430 can suggest revised term life insurance outcomes that reflect the replacement value of those cash flows should the user die earlier than actuarial models predict.

The financial plan model 400 may still further comprises an estate module (not shown) comprising estate rules to ensure that a user's indicated estate plans are considered in the financial plan model 400. Thus, the first stream of questions may prompt the user to respond to risk-assessment and beneficiary designation questions relevant to estate and insurance planning. For example, as shown in Table 1 above, the user may receive a request to indicate <dependent requirements> or <spousal requirements> for insurance aspects of the financial plan model 400. Similarly, any estate module may consider those inputs as well as others, such as desired estate size. The estate module imposes those estate constraints on the financial plan model 400 so that the user's investment contributions can meet those indicated estate objectives. The system 200 can incorporate the user's indicated estate objectives into wills or other documents reflecting the user's wishes. Those documents can be updated periodically to reflect revised objectives. The user's estate-related inputs can be supplemented by actuarial data available in the data storage system 300 or from external systems, platforms or databases, or from analysis of many users' aggregate data stored in the data storage system 300 using Monte-Carlo, machine-learning or other analytical methods.

Accordingly, the financial plan model 400 of FIG. 5 is an integrated model that, through the various incorporated modules, considers broad aspects of a user's financial plan. This ensures that all included aspects are considered in an integrated sense due to feedback between the modules. The application module 340 executes the instructions defining the financial plan model 400 using available inputs 25 to generate a plurality of intermediate outputs 403 shared between the modules, and a plurality of financial plan outputs 405 corresponding to the elements of a financial plan as presented to a user. The resulting set of financial plan outputs 405 are graphically arranged for presentation to a user according to a financial plan template 301 available in the data storage system 300. The data storage system 300 may contain various financial plan templates 301, each configured to present financial plan outputs according to one or more criteria, such as appearance, realized financial plan outputs 405, inputs 25 and user selection of a financial plan type.

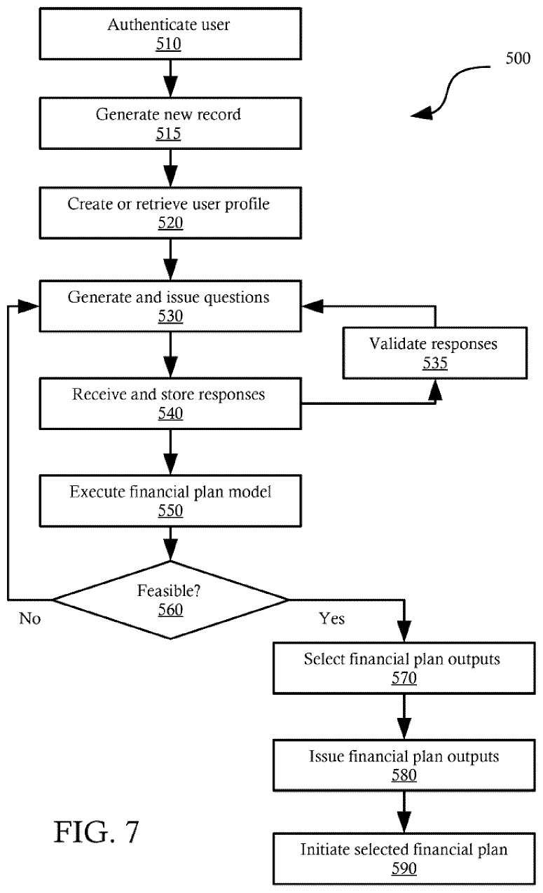

FIG. 6 illustrates a schematic of a user interface 124 presenting financial plan outputs 405 on the touchscreen 124 of a user computing device 110 according to the scheme defined by an example template 301 stored in the data storage system 300. The presented financial plan outputs 405 include the user's name, expected retirement age, expected retirement income, recommended insurance coverage and required savings to achieve the indicated retirement outcome, and lists inputs 25 representing assumptions that would lead to the indicated retirement outcome. The touchscreen 124 further presents a feedback prompt 126 which the user can engage to notify the server system 200 that he or she is prepared to proceed with the financial plan as presented. The server system 200 responds by engaging connected systems or platforms to purchase any financial instruments necessary to implement the user's selected financial plan, i.e., those financial instruments defined by the financial instrument profiles 305 stored in the data storage system 300 and incorporated into the financial plan model 400.

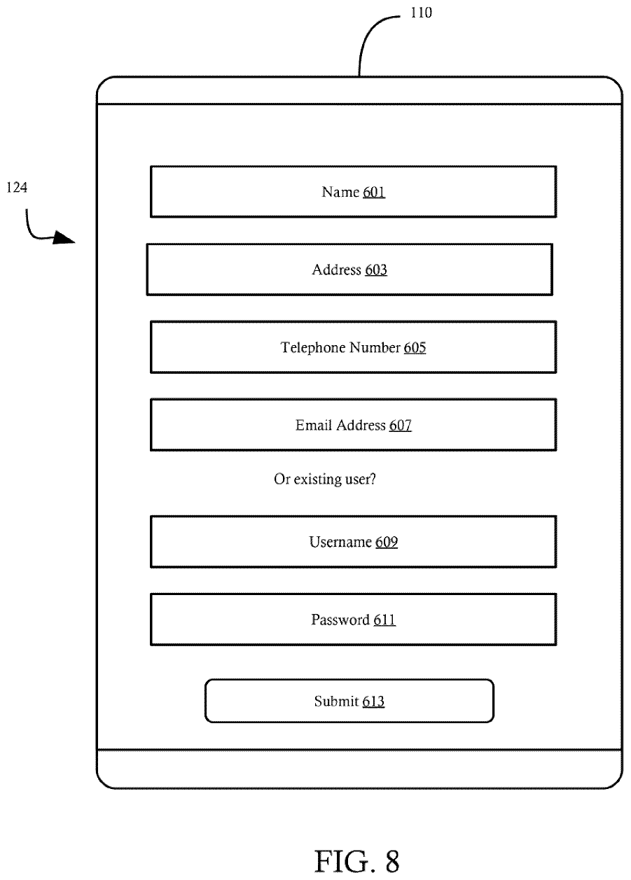

Referring now to FIG. 7, a process 500 illustrate methods for generating optimized financial plan outputs 405. The process 500 begins when a user at a user computing device 110 invokes an access the server system 200 to initiate a financial plan. Typically, if the server system 200 is accessed by the user operating a browser application on the user computing device 110 via a web server executing at the system 200, the instruction may be invoked by user actuation of a user interface element presented by the browser application. At block 510, the server system 200 implements the authentication service 320 to identify the user. The user is presented with a questionnaire via the user's browser which displays fields into which the user can enter identifying information. An example questionnaire as presented on the touchscreen 124 of the user computing device 110 is shown in FIG. 6. The questionnaire requests identification information or authentication information if the user has an existing profile, such as the user's name 601, address 603, telephone number 605, email address 607, username 609 and password 611. Of course, the questionnaire may request other identifiers that are recognizable by the system 200. The user initiates the issuance of the responses from the user computing device 110 to the server system over the network 10 by engaging the “submit” button 613 of the questionnaire. Since the illustrated user computing device 110 is a tablet-type or mobile device, the touchscreen 124 of the illustrated user computing device 110 combines display and input functions. However, it will be appreciated that user engagement with the financial planning platform may be through other display and input arrangements, such as a desktop with a monitor for display and a keyboard and mouse for user input functions of the user computing device 110.

At block 515, when the server system 200 has received the user's responses to the questionnaire from the user computing device 110, the application module 340 generates a new record for the financial plan unless the user is a returning user who wishes to access an existing financial plan. While “record” suggests a record in a database, the financial plan may be a file or collection of files defined and stored in the data storage system 300 in association with an identifier for the user who is initiating the financial plan, and an identifier identifying the financial plan in the data storage system 300, along with any system-defined inputs that can be defined upon initiation of the financial plan (e.g., timestamp indicating time of creation, last edit or revision date). Alternatively, if the authentication service 320 determines that the user is a returning user, the application module 340 may retrieve an existing record for that user from the data storage system 300, and ask the user whether he or she wishes to generate a new record, modify an existing record or revisit an existing record. At block 520, if the user is a new user, the server system 200 creates and stores a user profile for the user; if the user is a returning user, the server system 200 retrieves that user profile and associates it with any new financial plan record.

Following generation or retrieval of a financial plan record and user profile at blocks 515 and 520, at block 530 the application module 340 generates a first stream of questions and issues that first stream of questions over the network 10 to the user computing device 110 for presentation. If the user is a returning user, the system 200 already should have obtained a significant number of inputs from the user in a previous session. In that case, the user interface may present a confirmation interface presenting previously entered inputs which the user can confirm or edit in the present session. If the user confirms all existing entries, then the application module 340 either re-evaluates the user's financial plan in case of any changes since the user's previous session to system-defined inputs or the underlying financial plan model 400, or it retrieves previously generated financial plan outputs 405 for re-presentation to the user. In contrast, if the user is a new user or an existing user who wishes to edit previously provided responses, then the system 200 generates a first stream of questions for all outstanding inputs. If the user has accessed the server system 200 via a third-party platform serving as the authentication service, such as social media platforms or platforms provided by financial services providers, then those platforms may also provide the server system 200 with available inputs relating to the user. Thus, when generating the first stream of questions, the application module 340 may omit those questions to which responsive inputs are already known to it.

While the term “stream” is used in this disclosure, it will be appreciated that that term is not limiting. For example, the server system 200 may issue each stream of questions in a single instance, as a series of revisions, or in sequence following receipt of responses to those questions. Accordingly, those questions which are revised in response to received responses prior to execution of the entire financial plan model 400 are referred to as a “first” stream even though the server system 200 may issue adapted questions in response to validation of the received responses. Once the user has begun or finished entering a first stream of responses to the first stream of questions, the user computing device 110 transmits the first stream of responses over the network 10 to the server system 200 (referring to FIG. 1, the transmission of the stream of responses shown as element 25). The user computing device 110 may transmit the first stream of responses 25 in one or more batches or in near real-time whenever a connection to the system 200 is established. At block 540, the system receives the user's responses over the network 10 and may store them in the data storage system 300. The application module 340 may also validate those responses at block 535.

Whenever the system 200 receives a stream of responses 25, it may adaptively update the stream of questions at block 535 so that subsequent questions are based on responses to already received inputs within the stream of responses. For example, as described above, if the system has already received a response from the user that the user does not own a house, then the application module 340 may adapt the first stream of questions to omit any outstanding mortgage-related questions. The application module 340 may be configured to apply any suitable order to a stream of questions, such as in groups of questions under common areas of a financial plan (similar to the modules described above with reference to FIG. 5). Alternatively, the application module 340 may order the questions within the stream to obtain inputs from most to least influential relative to the other inputs. For example, a user's income, age and current savings generally are more likely to be influential to the overall financial plan than the user's weekly disbursements on groceries or grooming. By querying the more influential inputs first, the application module 340 can more easily validate each arriving input relative to earlier submitted inputs. For example, if the user's income at $75,000 per year is already entered, a validation rule in the mortgage module 310 may detect that the user's desired home mortgage of $5,000,000 exceeds the user's capacity to repay the mortgage. That may indicate an erroneous entry, either of the desired mortgage amount or the user's income. Since inputs generally are more likely to depend on the user's income than the user's desired home mortgage, presenting the income query ahead of the mortgage queries is likely to increase the likelihood of detecting erroneous entries and providing users with opportunities to correct such entries.

Amongst the inputs which the user provides to the system 200 in response to the first stream of questions, some define parameters that are fixed at the entry date, while others define targets or ranges relating to the user's objectives. Current income, assets, liabilities and expenditures reflect a snapshot of the user's financial situation at a moment in time. It follows that these are fixed parameters over which the user has no immediate control. In contrast, the user often can adjust activity to achieve different results or objectives in the future. Those future objectives may be defined as targets, ranges, or minimum or maximum variables. Thus, while the user's present income may be $100,000 and fixed on the date of entry, the user's future income, retirement age and retirement income may not be inherently fixed if the user has capacity to adjust his or her behaviour. Still, the user may prefer to achieve certain outcomes within a relatively narrow margin unless that is unfeasible.

Accordingly, at block 530, the first stream of questions may be configured to permit the user to specify fixed targets or ranges for objectives along with other parameters related to the user's current financial state; some questions may further permit the user to set an input that is variable in cases where the user has no preference about a particular outcome. As shown in the example in FIG. 9, then, the user interface 124 presenting the stream of questions may provide response fields where the user can enter values as ranges 701, targets 703, maximum values 705, minimum values 707 or indicate no preference 709. The user interface 124 further provides a submission dialogue 711 which the user can engage to submit the indicated response. User feedback can take any suitable form, such as digits or free text entry into a form submissions field of the user interface, or calendar selection, sliders, radials or dropdown selections. When the system 200 receives those responses, the application module 340 stores their inputs 25 in the data storage system 300 for incorporation during execution of the financial planning model 400.

At block 550, the application module 340 executes the financial plan model 400 using the inputs 25 stored in the data storage system 300 to obtain financial plan outputs 405 for possible presentation to the user. At block 560, the application module 340 assesses the generated financial plan outputs 405 for feasibility, that is, to determine whether the financial plan outputs 405 represent a financial plan that meets the user's fixed objectives given the parameters indicated by the user in response to the first stream of questions. For example, the application module 340 may determine whether the user's calculated estate is within a predefined or indicated range corresponding to a buffer or margin of error that would leave the user with a retirement income and desired estate even if the user's lifespan is longer than the financial plan model estimates, or to account for margins of error in predictions about future performance of markets and financial instruments. In many cases, the user's inputs 25 will lead to an unfeasible financial plan, that is, one which cannot meet the user's indicated fixed objectives given the entered parameters, such as if the target retirement age provided by the user is too low to provide the user's target retirement income given the user's current and anticipated savings rate.

Execution of the financial plan model 400 at block 550 comprises solving an optimization problem using suitable techniques to maximize or minimize aspects of the user's financial plan, such as retirement income, disposable income, tax paid, retirement age. Initially, to simplify data entry demanded of the user, the weight of each of these objectives may be predefined. If the financial plan model 400 is distributed amongst modules like those shown in FIG. 5, then the rules of each module may define constraints that must be satisfied. Accordingly, the financial plan model solves an optimization problem that seeks to maximize or minimize one or more objectives subject to various constraints in the rules defining the financial plan model 400.

Initially, the application module 340 respects the user's objectives by treating the user's objectives as fixed. In many cases, that is likely to lead to an unfeasible solution. If there is a feasible solution or set of feasible solutions, then at block 570, the system selects the set of outputs corresponding to the most optimal solution or subset of solutions from amongst the feasible solutions and issues their respective sets of financial plan outputs 405 at block 580 as described below in greater detail. However, if there are no feasible solutions, then the system returns to block 530, retrieves a second stream of questions 35, and issues the second stream of questions 35 to the user's device 110 over the network 10 to assess which of the user's previously indicated objectives the user will consider conceding, and to what extent, or the user's relative priorities amongst a plurality of the previously fixed (or idealized) objectives. When, at block 540, the server system 300 receives the user's second stream of responses 25 to this second stream of questions 35, it again stores those responses in the data storage system 300. At block 550, the application 340 relies on the inputs in the second stream of responses 25 to replace related previously fixed objectives (i.e., objectives specified as ranges or targets) with variable objectives. The substitution of variable for fixed objectives increases the likelihood of arriving at a feasible outcome without requiring the user or another operator to repeatedly and manually enter different targets or ranges for those objectives in an attempt to arrive at any feasible outcome. Table 3 below illustrates example questions from this second stream of questions 35, their corresponding inputs 25 and their associated substitutions in the financial plan model.

TABLE 3
Example questions is second stream of questions.

| Questions | Inputs | Substitutions |
|---|---|---|
| Would you consider | <desired | <retirement age> now a |
| retiring later? | retirement | variable to minimize rather |
| | age> | than a fixed range or target. |
| Would you consider using | <home equity> | <home equity> now a |
| home equity in retirement? | | variable considered with the |
| | | objective of minimizing the |
| | | size of any home equity |
| | | loan. |
| Work in retirement? | <retirement | <retirement employment |
| | employment | income> now factored into |
| | income> | accumulation calculations, |
| | | with objective of |
| | | minimizing the amount of |
| | | income derived from post- |
| | | employment income. |
| Increase savings? | <desired | <desired savings> now a |
| | savings> | variable to minimize rather |
| | | than a fixed limit, target or |
| | | range. |
| Reduce funding for child's | <milestone | <milestone amount> now a |
| education? | amounts> | variable to maximize rather |
| | | than a fixed target or range. |
| Inheritance? | <planned | |
| | windfalls> | |

It will be appreciated that the example questions illustrated in Table 3 above are not limiting. For example, the user may indicate flexibility with respect to more than one objective. Accordingly, the user could indicate a willingness to retire later and work in retirement. In another format, the application module 340 may generate a second stream of questions that instead asks a user to prioritize or rank objectives so that the application module, when executing the financial plan model 400 converts all fixed (target or range) objectives into variables while weighting each variable objective according to the rank assigned by the user.

Thus, once the application module 340 has substituted the inputs 25 received in response to the second stream of questions 35 and executed the financial plan model 400 with those substitutions, the application module 340 re-assesses the feasibility of the financial plan outputs 405 at block 560. If there still are no feasible solutions, the application module 340 repeats the steps at blocks 530-560 until at least one feasible solution is obtained. Otherwise, at block 570, the application module 340 selects from amongst the feasible sets of financial plan outputs 405 resulting from execution of the financial plan model 400 a subset of one or more most optimal financial plan outputs based on the objectives and constraints in the revised financial planning model 400. The application module 340 stores the selected subset of most optimal financial plan outputs 405 in the data storage system 300 in association with the user profile and record. The subset of most optimal financial plan outputs corresponds to one or multiple feasible financial plans. For example, the application module 340 may select the outputs 405 corresponding to the single most optimal plan for presentation to the user. Alternatively, the application module 340 may select two, three or more financial plans so that the user can choose a preferred plan based on criteria that may not have been discernible from the user's responses to any of generated streams of questions.

At block 580, the application module 340 issues the financial plan outputs 405 over the network 10 to the user computing device 110 for presentation according to a financial plan template 301 stored in the data storage system 300. As described above with reference to FIG. 6, the financial plan outputs 405 displayed to the user on the user computing device 110 may have an associated feedback prompt 126 which the user engages to confirm that he or she wishes to proceed with the associated financial plan. At block 590, the server system 200 receives the confirmation over the network 10 from the user computing device 110. In response to the confirmation, the system 200 associates the selected financial plan with the user and initiates services associated with acquiring the financial instruments profiled in the data storage system 300 that are required to actualize the selected financial plan. Since many of the inputs 25 provided by the user during the process 500 shown in FIG. 7 already provide responses to application forms required for various financial instruments, the server system 200 may use those inputs 25 to completely or partially complete such application forms on behalf of the user. The server system 200 may further generate another stream of questions 35 to obtain any inputs not required when generating the selected financial plan output 405 but required to apply for the relevant financial instruments. The stored association between the selected financial plan and the user permits the user to re-engage the system 200 in the future, for example, to view and update the selected financial plan.

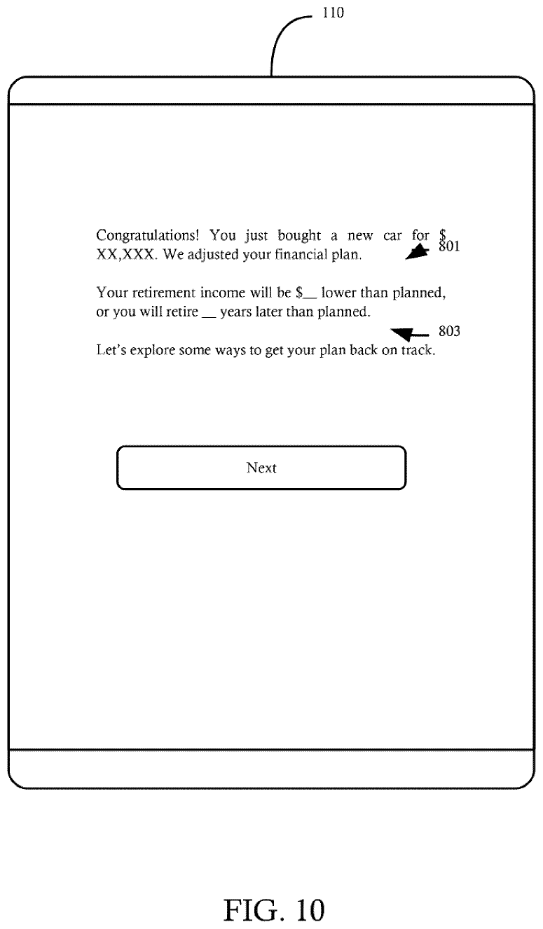

As described above, the system 200 may be linked to other systems, platforms or databases. Relying on data available from any connected platforms, the system 200 may periodically or continuously update the corresponding inputs underlying users' existing financial plans. For example, the system 200 may have access to market activity or users' banking activity. In those cases, the system 200 may reassess users' financial plans in response to material changes in input values based on underlying activity. The server system 200, then, may issue notifications to users by email, directly to their user computing device 110 over the network 10, SMS or other means, to inform users of updates. In one example scenario, the system 200 may learn from a user's bank card activity that the user has made a significant purchase not accounted for in the financial plan model underlying the user's confirmed financial plan. As shown in FIG. 10, the user may receive a notification over the network 10 at the user's device 110 that the user's retirement income will be reduced by an amount 801 or that the use's retirement age will increase by another amount 803 due to the purchase. The framing of the question may be based on stored preferences received from the user in response to the second stream of questions at block 540, described above. Thus, if the user indicated a preference to maximize retirement income over retirement age, the system 200 can generate a notification that describes the impact of the purchase in terms of a reduction in retirement income. Similarly, the user can access the system 200 to query the impact of a desired or anticipated purchase. For example, given the user's currently selected financial plan, the system 200 may indicate the impact on that plan if the user were to purchase a house at a given price by calculating a revised financial plan using that price as described above with reference to FIG. 7.

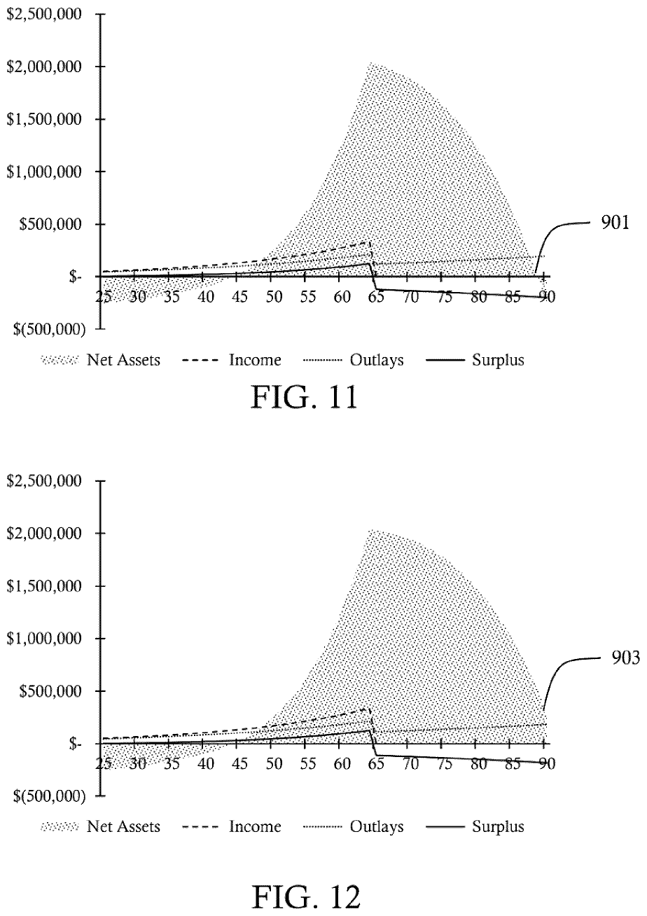

FIGS. 11 and 12, Table 4 and Table 5 below illustrate an example of a user's financial plan calculated according to the method 500 described above with reference to FIG. 7. Following the previously described steps at blocks 510-520, at block 530 the server system 200 receives from the user computing device 110 the user's first stream of responses 25 indicating the following information: the user's current age is 25; the user's current annual income and outlays are $50,000.00 and $46,000.00, respectively; the user's net assets stand at negative $250,000.00; the user wishes to retire at age 65; and the user wishes to begin retirement with available outlays of $120,000.00 per year. Those inputs 25 are shown in Table 4 below. The user also may have provided other responses within the first stream of responses which are not shown in the below tables.

At block 550, the application module 340 executes the financial plan model 400 using the user's inputs 25 in the first stream of responses. In the example shown in Table 4, the system also has defined other inputs (not shown), such as predicted income growth of 3% (plus inflation) per year for the user's indicated career, spending growth of 2% (plus inflation) during the user's working life, predicted asset growth of 5% for the user's indicated risk tolerance once the user has positive net assets, predicted inflation of 2%, and a predicted lifespan of 90 years. These system-defined inputs may be based, for example, on a combination of calculated, predicted or administrator-defined rates stored in the data storage system 300 or available in substantially real-time from external systems, platforms or databases, or based on prediction models applied to inputs received from the user in the first stream of responses. For example, the predicted growth rate for the user's surplus assets may be based on a combination of external or administrator-defined models and the user's responses to “know-your-client” questions included at block 530 in the first stream of questions to the user. Based on those inputs, the application module 340 assigns any available surplus from a given year to the user's net assets available at the beginning of the same year, as well as to any growth of those assets at the predicted rate of asset growth (in this case, 5% on net positive assets). Meanwhile, the application module 340 further appreciates the user's income and outlays by 5% and 4%, respectively, based on predicted inflation of 2%, predicted income growth of 3% and predicted growth in outlays at 2%. The income shown in Table 4 and Table 5 below generally represents employment income, not income from growth on assets; asset-based income is included in the asset growth rate of 3%. In Table 4, the surplus values, net assets, age 26-64 and 66+ income and outlays, and age 26+ net assets may represent the intermediate outputs 403 of various modules of the financial plan model 400, or financial plan outputs 405 destined for presentation to the user, as system-calculated intermediate values that do not move between modules of the financial plan model 400, or as pre-determined inputs retrieved from the data storage system 300.

When retirement begins at the user's desired retirement age of 65, the user's income declines to $0.00 and the user's former positive surplus becomes a deficit of $120,000.00 to provide for the user's desired initial retirement spending, which is drawn from the user's available net assets. The user's outlays continue to climb into retirement from the $120,000.00 initial retirement outlays due to predicted annual inflation of 2%. However, by the time the user reaches the predicted lifespan of 90 years, there are insufficient net assets from which to draw to provide the $196,872.72 in estimated outlays for the user. Accordingly, at block 560, the application module determines that the user's financial plan outputs 405 for the executed financial plan model 400 lead to an unfeasible outcome. The user's objectives of retiring at age 65 with a base retirement available outlay of $120,000.00 would be unfeasible. FIG. 11 depicts a chart illustrating the user's income, outlays, surplus and net assets at ages 25 through 90. When the user turns 89, the user's net assets revert from positive to negative as shown by the intersection 901 of the user's net assets and the x-axis of the chart. Not only is the plan unfeasible in real terms, but it may become unfeasible even earlier if the user has indicated a desired estate above $0.00.

TABLE 4
User's unfeasible financial plan

| Age | Income | Outlays | Surplus | Net Assets |
|---|---|---|---|---|
| 25 | $50,000.00 | $46,000.00 | $4,000.00 | −$250,000.00 |
| 30 | $63,814.08 | $55,966.03 | $7,848.04 | −$219,021.23 |
| 35 | $81,444.73 | $68,091.24 | $13,353.49 | −$164,032.81 |
| 40 | $103,946.41 | $82,843.40 | $21,103.01 | −$93,267.09 |
| 45 | $132,664.89 | $100,791.66 | $31,873.22 | $30,545.90 |
| 50 | $169,317.75 | $122,628.47 | $46,689.28 | $260,526.42 |
| 55 | $216,097.12 | $149,196.29 | $66,900.83 | $652,524.83 |
| 60 | $275,800.77 | $181,520.09 | $94,280.67 | $1,286,586.30 |
| 65 | $0.00 | $120,000.00 | −$120,000.00 | $2,025,215.86 |
| 70 | $0.00 | $132,489.70 | −$132,489.70 | $1,882,166.57 |
| 75 | $0.00 | $146,279.33 | −$146,279.33 | $1,626,470.39 |
| 80 | $0.00 | $161,504.20 | −$161,504.20 | $1,219,394.18 |
| 85 | $0.00 | $178,313.69 | −$178,313.69 | $610,711.34 |
| 90 | $0.00 | $196,872.72 | −$196,872.72 | −$264,555.96 |

In response to the generation of unfeasible financial plan outputs 405, at block 530, the application module issues a second stream of questions to identify which of the user's previously fixed objectives (in this case, retirement at age 65 with an initial available outlay of $120,000) the user would consider varying. For example, the application module 340 may issue a second stream of questions asking the user whether he or she would prefer to retire at 65 or reduce the outlays available in retirement. Table 5 below illustrates a new set of calculations performed by the application module 340 at block 550 based on the user's second stream of responses, which includes the following inputs: the user prefers reduced outlays over retiring after age 65. FIG. 12 depicts the results of Table 5 in chart form. Here, then, if the user's initial retirement outlays begin at $111,000, net assets at age 90 stand at $300,120.41. Referring to FIG. 12, the point 903 represents the user's net assets at age 90, above the x-axis extending from $0.00 on the y-axis. Assuming that is within the defined target at the end of the user's lifespan (for example, if the financial plan model 400 generally requires net assets of between $50,000.00 and $500,000 at death to account for the risk of exceeding the user's predicted lifespan), at block 560 the application module 340 determines that there is at least one set of feasible financial plan outputs.

TABLE 5
User's feasible financial plan

| Age | Income | Outlays | Surplus | Net Assets |
|---|---|---|---|---|
| 25 | $50,000.00 | $46,000.00 | $4,000.00 | −$250,000.00 |
| 30 | $63,814.08 | $55,966.03 | $7,848.04 | −$219,021.23 |
| 35 | $81,444.73 | $68,091.24 | $13,353.49 | −$164,032.81 |
| 40 | $103,946.41 | $82,843.40 | $21,103.01 | −$93,267.09 |
| 45 | $132,664.89 | $100,791.66 | $31,873.22 | $30,545.90 |
| 50 | $169,317.75 | $122,628.47 | $46,689.28 | $260,526.42 |
| 55 | $216,097.12 | $149,196.29 | $66,900.83 | $652,524.83 |
| 60 | $275,800.77 | $181,520.09 | $94,280.67 | $1,286,586.30 |
| 65 | $0.00 | $111,000.00 | −$111,000.00 | $2,034,215.86 |
| 70 | $0.00 | $122,552.97 | −$122,552.97 | $1,946,346.53 |
| 75 | $0.00 | $135,308.38 | −$135,308.38 | $1,766,559.91 |
| 80 | $0.00 | $149,391.39 | −$149,391.39 | $1,462,420.84 |
| 85 | $0.00 | $164,940.16 | −$164,940.16 | $991,800.21 |
| 90 | $0.00 | $182,107.27 | −$182,107.27 | $300,120.41 |

It will be appreciated that those aspects of the financial plan model 400 represented in Table 4, Table 5 and FIGS. 11 and 12 are merely examples of inputs, outputs, rules, assumptions and calculations that may be performed according to the method 500. Depending on other factors that are not necessarily represented in the assumptions and calculations underlying those tables and figures, other solutions may be possible. For example, the outlays shown in those tables and figures do not reflect other significant milestones, such as vehicle purchases, that might impact a user's financial plan; rather, they reflect an adjustment of a single example output that, according to the model represented in those tables, leads to at least one feasible outcome available in Table 5 but unavailable in Table 4. In at least one embodiment, the application module 340 can also issue a chart like those shown in FIGS. 11 and 12 to the user computing device 110 along with the second stream of questions at block 530 or along with subsets of most optimal financial plan outputs issued at block 580 for presentation to the user on the user computing device 110.

Following initiation of the user's selected financial plan at block 590, the system 200 may obtain periodic or real-time feedback, either from the user or from external systems, platforms or databases, to determine, on an ongoing basis, the continued feasibility of the plan, the user's compliance with the conditions of the plan, and the degree to which the plan is meeting the user's indicated objectives. Further, the system 200 may have stored in the data storage system 300 that user's and many other users' financial plans, so that the system 200 can identify larger trends in compliance or difficulties meeting indicated objectives. For example, the system 200 may comprise a machine learning engine (not shown) configured to learn from stored financial plans the degree of confidence that a generated financial plan will perform as expected. The system 200, then, can identify confidence intervals that are calculated during plan generation to offer greater certainty that the calculated plan will deliver within a range of confidence. The system 200 can further suggest and integrate insurance within the financial plan models to guarantee plans even beyond the calculated range of confidence for the plan in the absence of insurance. Similarly, the system 200 may monitor user activity to identify optimization opportunities from user misallocation of financial services products. For example, the system 200 may detect that a user is relying on a high-interest credit card loan when an available credit product would provide the same benefits more cheaply. The system 200 can then notify the user of that credit product and obtain the user's confirmation to obtain a loan through that credit product.

Aggregate sets of stored data from all or a plurality of users with profiles on the system 200 may further provide insights based on machine learning or other analytical methods to predict likely activity by a user if the user does not actively update the user's financial plan data. For example, a large jewellery purchase may foreshadow a wedding and investments in tax-reduced education savings accounts may foreshadow the birth of a child. Accordingly, the system 200 can prompt the user to confirm or deny the predicted activity and, if necessary, adjust the user's financial plan using any inputs relating to the confirmed activity, such as <milestone dates>, <milestone amounts> and others, and then notifying the user of the likely impact on that user's financial plan.

The examples and embodiments are presented only by way of example and are not meant to limit the scope of the subject matter described herein. Variations of these examples and embodiments will be apparent to those in the art, and are considered to be within the scope of the subject matter described herein. For example, some steps or acts in a process or method may be reordered or omitted, and features and aspects described in respect of one embodiment may be incorporated into other described embodiments.

The data employed by the systems, devices, and methods described herein may be stored in one or more data stores. The data stores can be of many different types of storage devices and programming constructs, such as RAM, ROM, flash memory, programming data structures, programming variables, and so forth. Code adapted to provide the systems and methods described above may be provided on many different types of computer-readable media including computer storage mechanisms (e.g., CD-ROM, diskette, RAM, flash memory, computer's hard drive, etc.) that contain instructions for use in execution by one or more processors to perform the operations described herein. The media on which the code may be provided is generally considered to be non-transitory or physical.

Computer components, software modules, engines, functions, and data structures may be connected directly or indirectly to each other in order to allow the flow of data needed for their operations. Various functional units have been expressly or implicitly described as modules, engines, or similar terminology, in order to more particularly emphasize their independent implementation and operation. Such units may be implemented in a unit of code, a subroutine unit, object (as in an object-oriented paradigm), applet, script or other form of code. Such functional units may also be implemented in hardware circuits comprising custom VLSI circuits or gate arrays; field-programmable gate arrays; programmable array logic; programmable logic devices; commercially available logic chips, transistors, and other such components. Functional units need not be physically located together, but may reside in different locations, such as over several electronic devices or memory devices, capable of being logically joined for execution. Functional units may also be implemented as combinations of software and hardware, such as a processor operating on a set of operational data or instructions.

It should also be understood that steps and the order of the steps in the processes and methods described herein may be altered, modified and/or augmented and still achieve the desired outcome. Throughout the specification, terms such as “may” and “can” are used interchangeably. Use of any particular term should not be construed as limiting the scope or requiring experimentation to implement the claimed subject matter or embodiments described herein. Any suggestion of substitutability of the data processing systems or environments for other implementation means should not be construed as an admission that the invention(s) described herein are abstract, or that the data processing systems or their components are non-essential to the invention(s) described herein. Further, while this disclosure may have articulated specific technical problems that are addressed by the invention(s), the disclosure is not intended to be limiting in this regard; the person of ordinary skill in the art will readily recognize other technical problems addressed by the invention(s).

1. A non-transitory computer-readable medium bearing code which, when executed by at least one processor of a computer system, causes the computer system to implement the method comprising:
issuing, over a network, a first stream of questions to a user computing device;
receiving, over the network, a first stream of inputs for a financial plan model in response to the first stream of questions, at least a subset of the first stream of inputs defining fixed objectives;
executing the financial plan model to generate one or more sets of financial plan outputs using the first stream of inputs;
assessing whether any of the sets of financial plan outputs is feasible for meeting the fixed objectives;
if any of the sets of financial plan outputs is feasible:
selecting a subset of most optimal financial plan outputs and issuing, over the network, the subset of most optimal financial plan outputs to the user computing device for presentation;
if none of the sets of financial plan outputs is feasible:
issuing, over the network, a second stream of questions to determine at least one of the fixed objectives from the first stream of inputs that can become variable objectives;
receiving, over the network, a second stream of inputs from the user interface device, at least a subset of the second stream of inputs defining at least one variable objective corresponding to at least one of the fixed objectives;
executing the financial plan model using the variable objectives in place of their corresponding fixed objectives to generate one or more sets of feasible financial plan outputs and, from amongst the sets of feasible financial plan outputs, selecting one or more subsets of most optimal feasible financial plan outputs in view of the objectives; and
issuing, over the network, the subsets of most optimal financial plan outputs to the user interface device for presentation.

2. The non-transitory computer-readable medium of claim 1, wherein the second stream of questions comprises questions regarding a user's priorities between any two or more of retirement age, retirement income, willingness to work in retirement, willingness to sell house to finance retirement, willingness to refinance house to finance retirement, and willingness to reduce education funding for a dependent.

3. The non-transitory computer-readable medium of claim 1, wherein the method comprises, in response to receiving an input indicating a financial milestone, periodically reallocating available investments amongst a plurality of investment instruments having different risk profiles to meet the user's risk tolerance for the financial milestones while maximizing returns on the available investments.

4. The non-transitory computer-readable medium of claim 1, wherein the financial plan model comprises insurance rules and the method comprises executing the insurance rules to identify, as at least one financial plan output, an insurance plan for the user.

5. (canceled)

6. The non-transitory computer-readable medium of claim 1, wherein the method further comprises, in response to receiving an updated input regarding the user from an external platform, re-executing the financial plan model using the updated input and issuing, over the network, a notification to the user computing device for presentation to indicate any changes in the subsets of most optimal financial plan outputs.

7. The non-transitory computer-readable medium of claim 1, wherein the financial plan model is modular.

8. The non-transitory computer-readable medium of claim 7, wherein the financial plan model comprises a plurality of modules, wherein each module is a mortgage module, a borrowing module, an insurance module, a goals module, an allocation module, an accumulation module, or a de-accumulation module.

9. A computer-implemented method, comprising:
by a communications subsystem, issuing, over a network, a first stream of questions to a user computing device;
by the communications subsystem, receiving, over the network, and storing in memory, a first stream of inputs for a financial plan model in response to the first stream of questions, at least a subset of the first stream of inputs defining fixed objectives;
by a processor, executing the financial plan model to generate one or more sets of financial plan outputs using the first stream of inputs;
by the processor, assessing whether any of the sets of financial plan outputs is feasible for meeting the fixed objectives;
if any of the sets of financial plan outputs is feasible:
by the processor, selecting one or more subsets of most optimal financial plan outputs and issuing, by the communications subsystem over the network, the subsets of most optimal financial plan outputs to the user computing device for presentation;
if none of the sets of financial plan outputs is feasible:
issuing, by the processor, over the network, a second stream of questions to determine at least one of the fixed objectives from the first stream of inputs that can become variable objectives;
receiving, by the communications subsystem, over the network, and storing in the memory, a second stream of inputs from the user computing device, at least a subset of the second stream of inputs defining at least one variable objective corresponding to at least one of the fixed objectives;
executing, by the processor, the financial plan model using the variable objectives in place of their corresponding fixed objectives to generate one or more feasible sets of financial plan outputs and, from amongst the feasible sets of financial plan outputs, selecting one or more subsets most optimal feasible financial plan outputs in view of the objectives; and
issuing, by the communications subsystem, over the network, the subsets of most optimal financial plan outputs to the user computing device for presentation.

10. The computer-implemented method of claim 9, wherein the second stream of questions comprises questions regarding a user's priorities between any two or more of retirement age, retirement income, willingness to work in retirement, willingness to sell house to finance retirement, willingness to refinance house to finance retirement, and willingness to reduce education funding for a dependent.

11. The computer-implement method of claim 9, wherein the method comprises, in response to receiving an input indicating a financial milestone, periodically reallocating available investments amongst a plurality of investment instruments having different risk profiles to meet the financial milestones while maximizing returns on the available investments.

12. The computer-implemented method of claim 9, wherein the financial plan model comprises insurance rules and the method comprises executing the insurance rules to identify, as at least one financial plan output, an insurance plan for the user.

13. (canceled)

14. The computer-implemented method of claim 9, wherein the method further comprises, in response to receiving an updated input regarding the user from an external platform, re-executing the financial plan model using the updated input and issuing, over the network, a notification to the user computing device for presentation to indicate any changes in the subsets of most optimal financial plan outputs.

15. The computer-implemented method of claim 9, wherein the financial plan model is modular.

16. The computer-implemented method of claim 15, wherein the financial plan model comprises a plurality of modules, wherein each module is a mortgage module, a borrowing module, an insurance module, a goals module, an allocation module, an accumulation module, or a de-accumulation module.

17. A computer system, comprising:
a memory;
a communications subsystem;
at least one processor in operative communication with the memory and the communications subsystem, the at least one processor being configured to:
issue, over a network, a first stream of questions to a user computing device;
receive, over the network, and store in the memory, a first stream of inputs for a financial plan model in response to the first stream of questions, at least a subset of the first stream of inputs defining fixed objectives;
execute the financial plan model to generate one or more sets of financial plan outputs using the first stream of inputs;
assess whether any of the sets of financial plan outputs is feasible for meeting the fixed objectives;
if any of the sets of financial plan outputs is feasible:
select one or more subsets of most optimal financial plan outputs and issue, over the network, the subsets of most optimal financial plan outputs to the user computing device for presentation;
if none of the sets of financial plan outputs is feasible:
issue, over the network, a second stream of questions to determine at least one of the fixed objectives from the first stream of inputs that can become variable objectives;
receive, over the network, and store in the memory, a second stream of inputs from the user computing device, at least a subset of the second stream of inputs defining at least one variable objective corresponding to at least one of the fixed objectives;
execute the financial plan model using the variable objectives in place of their corresponding fixed objectives to generate one or more feasible sets of financial plan outputs and, from amongst the feasible sets of financial plan outputs, select one or more subsets most optimal feasible financial plan outputs in view of the objectives; and
issue, over the network, the subsets of most optimal financial plan outputs to the user computing device for presentation.

18. The computer system of claim 17, wherein the second stream of questions comprises questions regarding a user's priorities between any two or more of retirement age, retirement income, willingness to work in retirement, willingness to sell house to finance retirement, willingness to refinance house to finance retirement, and willingness to reduce education funding for a dependent.

19. The computer system of claim 17, wherein the processor is further configured to, in response to receiving an input indicating a financial milestone, periodically reallocate available investments amongst a plurality of investment instruments having different risk profiles to meet the financial milestones while maximizing returns on the available investments.

20. The computer system of claim 17, wherein the financial plan model comprises insurance rules and the method comprises executing the insurance rules to identify, as at least one financial plan output, an insurance plan for the user.

21. (canceled)

22. The computer system of claim 17, wherein the processor is further configured to, in response to receiving an updated input regarding the user from an external platform, re-execute the financial plan model using the updated input and issue, over the network, a notification to the user computing device for presentation to indicate any changes in the subsets of most optimal financial plan outputs.

23. The computer system of claim 17, wherein the financial plan model is modular.

24. The computer-system of claim 23, wherein the financial plan model comprises a plurality of modules, wherein each module is a mortgage module, a borrowing module, an insurance module, a goals module, an allocation module, an accumulation module, or a de-accumulation module.
